(19) United States
(12) Patent Application Publication
(10) Pub. No.: US 2024/0005143 A1
(43) Pub. Date: Jan. 4, 2024

(54) MACHINE LEARNING FOR POWER CONSUMPTION ATTRIBUTION

(71) Applicant: Capital One Services, LLC, McLean, VA (US)

(72) Inventors: Lee ADCOCK, Midlothian, VA (US); Mehulkumar Jayantilal GARNARA, Glen Allen, VA (US); Vamsi KAVURI, Glen Allen, VA (US)

(73) Assignee: Capital One Services, LLC, McLean, VA (US)

(21) Appl. No.: 17/810,108

(22) Filed: Jun. 30, 2022

(51) Int. Cl. G06N 3/08

(52) U.S. Cl. CPC G06N 3/08

(57) ABSTRACT

A computing system may use time series data and machine learning to attribute power consumption to various devices in a location. The computing system may obtain time series data indicating a total amount of electricity being used at a location over time. The computing system may use a machine learning model, which has been trained to recognize devices based on an amount of electricity being used, to identify the devices at the location and determine how much electricity each device is using. Further, the computing system may use the machine learning model to detect changes in electricity consumption that may enable determination of devices that need to be repaired, turned on, or reconnected to the power source.

### BACKGROUND

Over the past few years, people have been acquiring more and more electronic devices that are either plugged into electric outlets at home or use electric outlets at home to charge. Thus, tracking electricity usage has become more important so that electricity may be used more efficiently. A user may want to know which devices are consuming electricity and how much they are consuming. For example, this knowledge may enable the user to make adjustments to their usage to reduce waste or identify a device that is malfunctioning. In some instances, if a user would like to know how much electricity a device is using, the user may install an electricity usage monitor at each individual outlet. The electricity usage monitor may display how many kilowatt hours (kWh) are being used by an individual device.

While conventional electricity usage monitors may allow for the measurement of power usage at individual outlets or circuits at a location (e.g., a home), there are many drawbacks to their use. For example, they need to be separately purchased and installed which may be costly, they add clutter to the location, and they may require replacement or repair over time. Further, the measurements from each outlet then need to be aggregated to generate an overall report. Additionally, the electricity usage monitors may not be able to detect changes in usage over time and may be unable to determine, for example, when a device is not working properly, because the amount of power it is consuming has changed.

### SUMMARY

To solve these problems, nonconventional methods and systems described herein use time series data and machine learning to attribute power consumption to various devices in an environment (e.g., a building, a recreation center, a house, an outdoor location, etc.). That is, methods and systems described herein do not require use of conventional electricity usage monitors to determine which devices are connected to a premises' power source and how much electricity those devices are using. Specifically, a computing system may obtain time series data indicating a total amount of electricity being used at a premises over time. The computing system may use a machine learning model that has been trained to recognize devices, based on an amount of electricity being used, to identify the devices at the premises and determine how much electricity each device is using. Furthermore, the computing system may use the machine learning model to detect changes in electricity consumption that may enable determination of devices that need to be repaired, turned on, or reconnected to the power source.

In some embodiments, a computing system may obtain time series data corresponding to a time period of electricity consumption at a premises. For example, the time series data may indicate how much power was being consumed every minute during a one-week time period. The computing system may input the time series data into a machine learning model. The machine learning model may generate output that identifies one or more devices and an amount of power each device used during the time period. For example, the machine learning model may have been trained using labeled time series training data to identify devices based on power consumption at a premises. The labeled time series training data may include labels indicating devices and how much power each device used. The computing system may send a message to a user device based on the output of the machine learning model. For example, the message may include a summary of the devices and amount of electricity each is consuming. The message may include an identification of a device that is determined to be in need of repair (e.g., a broken refrigerator).

Various other aspects, features, and advantages of the disclosure will be apparent through the detailed description of the disclosure and the drawings attached hereto. It is also to be understood that both the foregoing general description and the following detailed description are examples and not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion,” refers to a part of, or the entirety of (i.e., the entire portion), a given item (e.g., data) unless the context clearly dictates otherwise.

### BRIEF DESCRIPTION OF THE DRAWINGS

FIG. 1 shows an example system for attributing power consumption in accordance with some embodiments.

FIG. 2A shows example time series data for power consumption attribution in accordance with some embodiments.

FIG. 2B shows an example separation of time series data to show the individual devices that account for the time series data in accordance with some embodiments.

FIG. 2C shows example output that may be generated via a machine learning model in accordance with some embodiments.

FIG. 3 shows an example machine learning model in accordance with some embodiments.

FIG. 4 shows an example flowchart of the actions involved in attributing power consumption to devices in accordance with some embodiments.

FIG. 5 shows an example computing system that may be used in accordance with some embodiments.

### DETAILED DESCRIPTION OF THE DRAWINGS

In the following description, for the purposes of explanation, numerous specific details are set forth in order to provide a thorough understanding of the disclosure. It will be appreciated, however, by those having skill in the art, that the disclosure may be practiced without these specific details or with an equivalent arrangement. In other cases, some structures and devices are shown in block diagram form to avoid unnecessarily obscuring the disclosure.

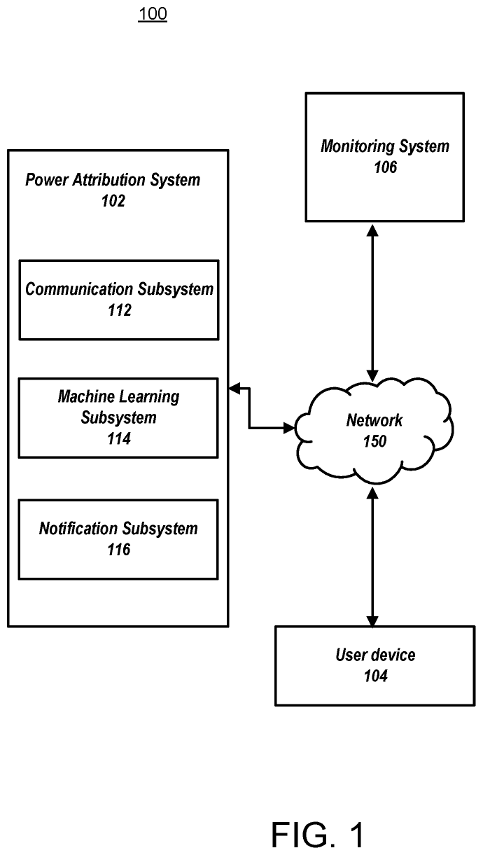

FIG. 1 shows an example computing system 100 for determining devices connected to a power source and the amount of power consumed by each device. The system 100 may include a power attribution system 102, a monitoring system 106, or a user device 104. The power attribution system 102 may include a communication subsystem 112, a machine learning subsystem 114, a notification subsystem 116, and/or other components. The power attribution system 102 may be hosted on its own device (e.g., a server, etc.) or it may be hosted on the user device 104. The communication subsystem 112 may receive input from the user device 104 or from the monitoring system 106.

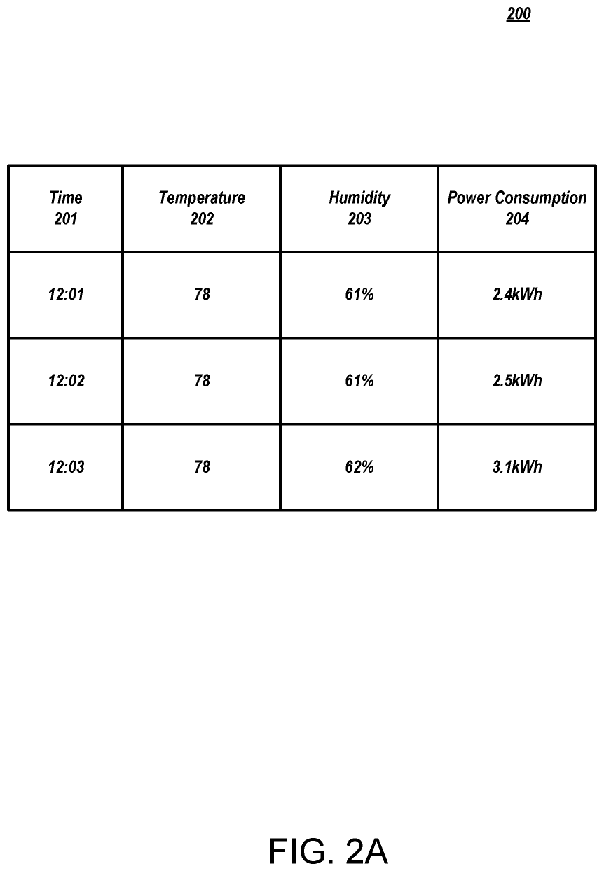

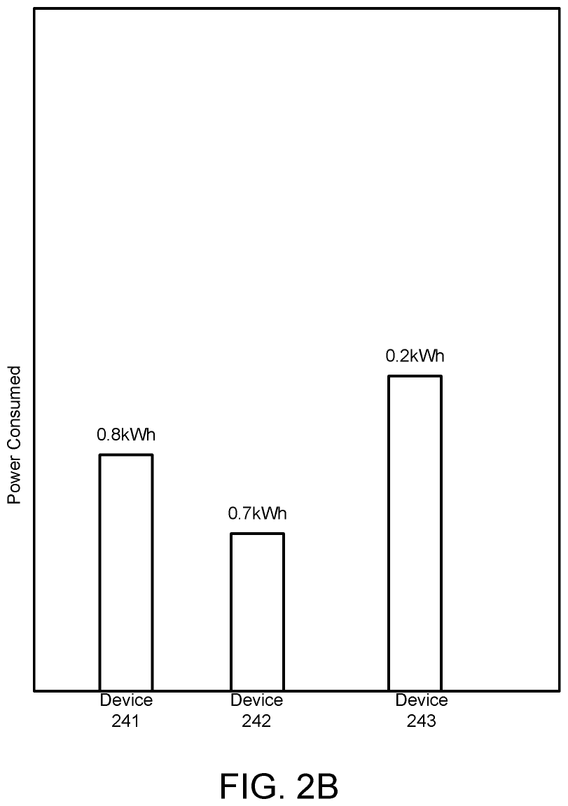

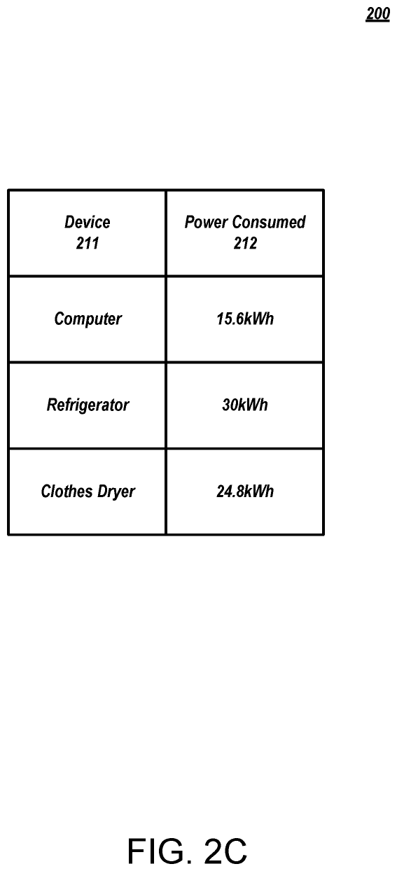

The monitoring system 106 may be a power meter or other electricity/power measuring device. The monitoring system 106 may record the amount of electricity (e.g., kWh) being used at a premises at regular intervals. For example, the monitoring system 106 may record the amount of electricity being used every minute, every half hour, every hour, etc. The electricity measured by the monitoring system 106 may include the total amount of electricity being used at the premises. For example, each measurement may include all electricity being used at a house or other premises at each interval (e.g., as discussed in more detail below in connection with FIG. 2A). The monitoring system 106 may communicate with the power attribution system 102 (e.g., via the communication subsystem 112) to send the power consumption measurements recorded at the premises. For example, the monitoring system 106 may send the measurements to the attribution system periodically (e.g., once per day, once per week, once per month, etc.). The measurements may be used to create time series data that may be input into a machine learning model as described in more detail below.

The power attribution system 102 may obtain (e.g., from the monitoring system 106) time series data corresponding to a time period of electricity or power consumption at a premises. The premises may be, for example, a house, a place of business, a recreational area, a factory, or a variety of other locations that use electricity or power. The time series data may indicate a quantity of electricity used (e.g., kWh) during each interval of a plurality of intervals within the time period. For example, an interval may be one minute long, and the time series data may indicate how much power was consumed at a house every minute (e.g., plurality of intervals) for a time period of one month. The monitoring system 106 (e.g., a power meter) may take a measurement once every interval to determine how much total power is being consumed at the premises.

In some embodiments, weather information at the premises may be added to the time series data for each interval of the plurality of intervals. For example, the outside temperature for every minute during the time period of one month may be added to the time series data. The weather information may be obtained from a server via an application programming interface and joined with the time series data. The weather information may indicate a temperature, humidity, chance of precipitation, cloud cover, or a variety of other weather conditions. A machine learning model may use the weather information together with electricity consumption time series data to determine how much power is being consumed by one or more devices at the premises. For example, a refrigerator or air conditioning unit may use more electricity when the weather is hot outside (e.g., above 70 degrees Fahrenheit). The time series data may include other information about the area around the premises. For example, the time series data may indicate the number of trees or other objects within the property boundaries associated with the premises. The number of trees may indicate whether the premises is shaded and may therefore use less electricity for cooling due to the shade. The machine learning model may be trained to use this data to identify devices consuming electricity.

FIG. 2A shows example time series data 200 that may be used in accordance with some embodiments. The data 200 may include a column 201 indicating a time that each data entry was recorded. The data 200 may include a column 202 indicating a temperature (e.g., outside temperature at or near the premises) that was recorded for the data entry. The data 200 may include column 203 indicating a humidity level (e.g., outside humidity at or near the premises) that was recorded for the data entry. The data may include a column 204 indicating how much power was being consumed at the premises and at the corresponding time indicated in column 201. For example, the table may indicate that a 2.4 kWh was being consumed at 12:01 pm, 2.5 kWh was being consumed at 12:02 pm, and 3.1 kWh was being consumed at 12:03 pm.

The power attribution system 102 may generate a plurality of streams of time series data, for example, based on the time series data. A stream may be a portion of the total power consumption (e.g., in column 204 of FIG. 2A) that can be attributable to a particular device. A stream may be derived from the time series data. A stream may be a frequency of electricity consumption for one device or a portion of the time series data that corresponds to a single device. A stream may indicate how much power was consumed at each interval (e.g., every minute) by a particular device during the time period. For example, a stream corresponding to a refrigerator may indicate that the refrigerator uses 120 watts of electricity every 30 minutes. Each stream of the plurality of streams may correspond to a device of the plurality of devices that has used electricity during the time period. In some embodiments, the power attribution system 102 may use signal or frequency analysis techniques (e.g., the Fourier transform) to determine the plurality of streams. The power attribution system 102 may determine a plurality of Fourier frequencies within the time series data. For example, the power attribution system 102 may compute the discrete Fourier transform (DFT) of the time series data by decomposing the time series data into components of different frequencies. The power attribution system 102 may generate, based on the plurality of Fourier frequencies, the plurality of streams of time series data. For example, each Fourier frequency may correspond to a device that is consuming power at the premises.

In some embodiments, the power attribution system 102 may use a machine learning model to determine the plurality of streams based on the time series data. For example, a machine learning model may be able to detect patterns of power usage (e.g., when the devices are turning off and on, when the amount of electricity used by a device changes, etc.) and determine a plurality of streams that, when combined, form the time series data. In some embodiments, the machine learning model may be a neural network. The machine learning model may have been trained using supervised machine learning techniques. The training data may include time series data as (e.g., as shown in FIG. 2A). The data may further include a labeled column. Each row of the labeled column may include a map data structure that includes a list of devices and how much power they are consuming for the corresponding time interval. The machine learning model may use the labeled data to train and predict each device or the amount of power each device is consuming for data that the machine learning model has not been trained on.

In some embodiments, user input may be used to help (e.g., seed) the machine learning model to increase the accuracy of the machine learning model. The user may input a number of devices that are known to consume power at the premises. For example, the user may input kitchen appliances, types of computers (e.g., laptops, desktops, mobile devices, etc.), household chore devices (e.g., laundry machine, dishwasher, vacuum cleaner, etc.) or a variety of other devices that are known to use power at the premises. Providing an initial list of devices may allow the machine learning model to more accurately determine how much power each device is consuming.

The user input may further indicate which devices are critical devices. Critical devices may be devices for which the user wishes to receive notifications about. The attribution system may send notifications, for example, when a critical device is no longer detected to be using power (e.g., indicating that the device has been turned off or is not working properly), as described in more detail below.

In some embodiments, the plurality of streams (e.g., generated using a Fourier transform as described above) may be input into a machine learning model. The machine learning model may generate output indicating an identification of each device and an amount of power each device used during the time period. The machine learning model may be trained with training data that includes a plurality of streams and corresponding labels that indicate what device each stream should be identified as. For example, one instance of the training data my include a stream and a label indicating that the stream should be classified as an air conditioning device. Output identifying each device may be generated via the machine learning model, for example, in response to inputting the plurality of streams of time series data into the machine learning model.

In some embodiments, the power attribution system 102 may use multiple machine learning models to determine an amount of power each device used during the time period. For example, a first machine learning model may take the time series data as input and generate output indicating a stream (e.g., a pattern or frequency of power consumption) for each device of a plurality of devices. The output of the first machine learning model may be a plurality of streams (e.g., patterns of power consumption, frequencies of power consumption, etc.) indicating how much power was used at different intervals by each corresponding device. The amounts of power indicated in a stream may be summed to determine the total amount of power used by the corresponding device during the time period. The first machine learning model may be trained using training data that includes time series data and labels that indicate what streams each instance of the time series data includes. For example, one instance of the training data may include time series data and a label that includes streams for a refrigerator and a computer.

A second machine learning model may be used to classify each device, based at least in part, on the corresponding stream output by the first machine learning model. The second machine learning model may take as input the plurality of streams output by the first machine learning model. The second machine learning model may generate output for each stream indicating an identification of a device corresponding to a stream. For example, the second machine learning model may generate a plurality of probabilities corresponding to a list of devices. Each device in the list may have a corresponding probability indicating whether the device was using power at the premises or not. The second machine learning model may be trained using training data that includes streams and a label for each stream indicating what device the corresponding stream should be classified as.

In some embodiments, a single machine learning model may perform some or all of the functionality of both the first and second machine learning models. For example, a single machine learning model may take as input the time series data and may output an identification of each device that is consuming power at the location and an amount of power each device is consuming.

FIG. 2B shows an example summation of output from a machine learning model (e.g., the first machine learning model) in graph form. The first machine learning model may generate output corresponding to device 241, device 242, and device 243. The output for each device may be summed to determine the total amount of power consumed by each device. For example, the first machine learning model may generate output indicating that a device 241 used 0.8 kWh, a device 242 used 0.7 kWh, and a device 243 used 0.2 kWh during a time period. The second machine learning model may use the output from the first machine learning model to classify each device. For example, the second machine learning model may classify the device 241 as a computer, the device 242 as an oven, and the device 243 as a light bulb.

In some embodiments, the machine learning model may determine that multiple devices are of the same type. Multiple devices of the same type may be aggregated together such that when a user is notified of the power consumed by the devices, the amount of power is grouped together. For example, if multiple light bulbs are detected, the power attribution system 102 may group them into a single group and sum the amount of power used by each device into one total amount. For example, if ten light bulbs are detected consuming 0.1 kWh during the time period, the power attribution system 102 may generate output indicating that light bulbs consumed 1 kWh. The power attribution system 102 may determine that a subset of the plurality of streams of time series data corresponds to a first type of device. Based on determining that the subset corresponds to the first type of device, the power attribution system 102 may aggregate the output for each stream in the subset.

In some embodiments, the power attribution system 102 may determine (e.g., via the machine learning model) that the amount of power consumed by a device has changed over time. A change in power consumption may indicate that a device is not working correctly and may need to be repaired. The power attribution system 102 may notify the user of any changes to enable problems to be diagnosed more efficiently. The power attribution system 102 may determine, based on previous output of the machine learning model, that power consumption by the first device has increased over a threshold period of time. In response to determining that power consumption by the first device has increased over a threshold period of time, the power attribution system 102 may send an indication (e.g., to the user device 104) that power consumption by the first device has increased.

The power attribution system 102 may look for anomalies in power consumption to determine whether a device is working properly. The power attribution system 102 may determine that a first stream of the plurality of streams of time series data corresponds to a first device. The power attribution system 102 may determine, based on an anomaly detection model, that the first stream comprises an anomaly. For example, the anomaly detection model may be a machine learning model that has been trained to detect anomalies in time series data. Each stream may be input into the anomaly detection model and the model may generate output indicating whether each stream is anomalous or not. For example, the anomaly detection model may output a score for each input stream. If the score is above a threshold score, the stream (and its corresponding device) may be determined to be anomalous. The power attribution system 102 may send a notification to a user indicating any device that is determined to be anomalous. For example, in response to determining that the first stream is anomalous, the power attribution system 102 may send (e.g., to the user device 104) a recommendation to repair the first device.

The power attribution system 102 may detect when a new device begins consuming power at the premises or when a device ceases to use power at the premises. For example, in response to inputting the time series data into the machine learning model, the power attribution system 102 may generate (e.g., via the machine learning model), second output indicating that a new device is consuming electricity at the premises. In response to generating second output indicating that a new device is consuming electricity, the power attribution system 102 may send a second notification to the user device indicating that a new device is consuming electricity. To determine whether a device has ceased to use power at the premises (e.g., the device is turned off, the device is broken, etc.), the power attribution system 102 may compare the machine learning model's output with previous data generated by the machine learning model (e.g., previous output). Based on comparing the output with previous data generated by the machine learning model, the power attribution system 102 may determine that a second device is missing from the output. In response to determining that a second device is missing from the output, the power attribution system 102 may send a second notification to the user device. For example, the second notification may indicate that the second device is off or disconnected from the power source at the premises.

In some embodiments, the output may include an amount of power consumed by devices that the machine learning model was not able to identify. For example, the machine learning model may generate a confidence score for each identified device. If the confidence score is too low (e.g., below a threshold score), the power attribution system 102 may determine that no identification can be made for the corresponding device.

The power attribution system 102 may send a message indicating an amount of power used by one or more devices at the premises. The message may be sent to the user device 104. The message may include a table listing the devices and an amount of power each device consumed. For example, referring to FIG. 2C, an example table that may be included in a message to the user device 104 is shown. The contents of the table may be generated via a machine learning model implemented by the machine learning subsystem 114. The table may include a device column 211 for devices and a power consumed column 212 for power consumed by each device. The table may correspond to a period of time (e.g., one month, one week, one year, etc.). For example, column 211 indicates that a computer used 15.6 kWh, a refrigerator used 30 kWh, and a clothes dryer used 24.8 kWh during the corresponding period of time.

In some embodiments, the power attribution system 102 may generate and send recommendations to the user device 104. The recommendations may include changes in power consumption that should be made for one or more devices (e.g., one or more devices detected and identified by the power attribution system 102). A recommendation may indicate a time at which a device should be run (e.g., off peak when electricity costs less rather than on peak when electricity costs more). For example, if the power attribution system 102 detected a device (e.g., a washing machine, a dryer, a dishwasher, etc.) that was using electricity during a first time period (e.g., on peak when electricity costs more), the power attribution system 102 may generate a recommendation indicating that the device should be run during a second time period (e.g., off peak when electricity costs less). The power attribution system 102 may include the recommendation in a message (e.g., a message as described above) sent to the user device 104.

The user device 104 may be any computing device, including, but not limited to, a laptop computer, tablet computer, handheld computer, smartphone, or other computer equipment (e.g., a server or virtual server), including “smart,” wireless, wearable, or mobile devices. The power attribution system 102 may include one or more computing devices described above or may include any type of mobile terminal, fixed terminal, or other device. For example, the power attribution system 102 may be implemented as a cloud-computing system and may feature one or more component devices. A person skilled in the art would understand that system 100 is not limited to the devices shown in FIG. 1. Users may, for example, utilize one or more other devices to interact with devices, one or more servers, or other components of system 100. A person skilled in the art would also understand that while one or more operations are described herein as being performed by particular components of the system 100, those operations may, in some embodiments, be performed by other components of the system 100. As an example, while one or more operations are described herein as being performed by components of the power attribution system 102, those operations may be performed by components of the user device 104, or monitoring system 106. In some embodiments, the various computers and systems described herein may include one or more computing devices that are programmed to perform the described functions.

One or more components of the power attribution system 102, user device 104, or monitoring system 106 may receive content or data via input/output (I/O) paths. The one or more components of the power attribution system 102, the user device 104, or the monitoring system 106 may include processors or control circuitry to send and receive commands, requests, and other suitable data using the I/O paths. The control circuitry may include any suitable processing, storage, or I/O circuitry. Each of these devices may include a user input interface or user output interface (e.g., a display) for use in receiving and displaying data. It should be noted that in some embodiments, the power attribution system 102, the user device 104, or the monitoring system 106 may have neither user input interfaces nor displays and may instead receive and display content using another device (e.g., a dedicated display device such as a computer screen or a dedicated input device such as a remote control, mouse, voice input, etc.).

One or more components or devices in the system 100 may include electronic storages. The electronic storages may include non-transitory storage media that electronically stores information. The electronic storage media of the electronic storages may include one or both of (a) system storage that is provided integrally (e.g., substantially non-removable) with servers or client devices or (ii) removable storage that is removably connectable to the servers or client devices via, for example, a port (e.g., a Universal Serial Bus (USB) port, a firewire port, etc.) or a drive (e.g., a disk drive, etc.). The electronic storages may include one or more of optically readable storage media (e.g., optical discs, etc.), magnetically readable storage media (e.g., magnetic tape, magnetic hard drive, floppy drive, etc.), electrical charge-based storage media (e.g., electrically erasable programmable read-only memory (EEPROM), random access memory (RAM), etc.), solid-state storage media (e.g., flash drive, etc.), or other electronically readable storage media. The electronic storages may include one or more virtual storage resources (e.g., cloud storage, a virtual private network, or other virtual storage resources). The electronic storages may store software algorithms, information determined by the processors, information obtained from servers, information obtained from client devices, or other information that enables the functionality as described herein.

FIG. 1 also includes a network 150. The network 150 may be the Internet, a mobile phone network, a mobile voice or data network (e.g., a 5G or LTE network), a cable network, a satellite network, a combination of these networks, or other types of communications networks or combinations of communications networks. The devices in FIG. 1 (e.g., power attribution system 102, the user device 104, or the monitoring system 106) may communicate (e.g., with each other or other computing systems not shown in FIG. 1) via the network 150 using one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The devices in FIG. 1 may include additional communication paths linking hardware, software, or firmware components operating together. For example, the power attribution system 102, any component of the processing system (e.g., the communication subsystem 112, the machine learning subsystem 114, or the notification subsystem 116), the user device 104, or the monitoring system 106 may be implemented by one or more computing platforms.

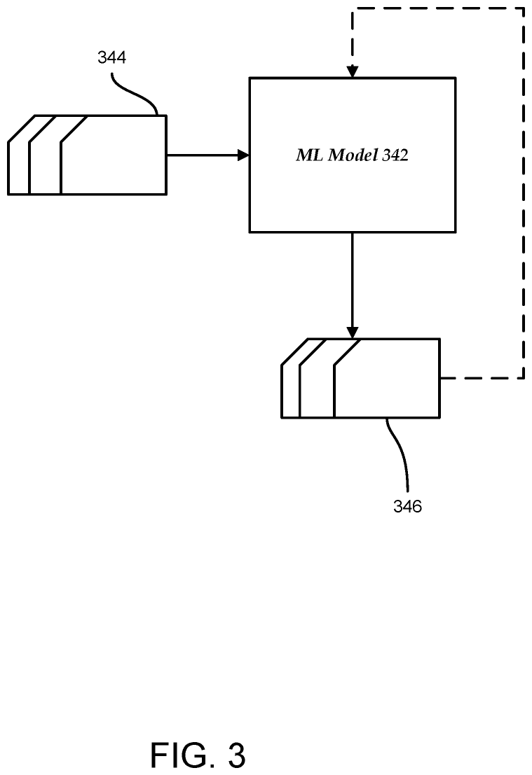

One or more machine learning models discussed above may be implemented (e.g., in part), for example, as shown in FIGS. 1-3. With respect to FIG. 3, machine learning (ML) model 342 may take inputs 344 and provide outputs 346. In one use case, outputs 346 may be fed back to machine learning model 342 as input to train machine learning model 342 (e.g., alone or in conjunction with user indications of the accuracy of outputs 346, labels associated with the inputs, or with other reference feedback information). In another use case, machine learning model 342 may update its configurations (e.g., weights, biases, or other parameters) based on its assessment of its prediction (e.g., outputs 346) and reference feedback information (e.g., user indication of accuracy, reference labels, or other information). In another example use case, machine learning model 342 is a neural network and connection weights may be adjusted to reconcile differences between the neural network's prediction and the reference feedback. In a further use case, one or more neurons (or nodes) of the neural network may require that their respective errors are sent backward through the neural network to them to facilitate the update process (e.g., backpropagation of error). Updates to the connection weights may, for example, be reflective of the magnitude of error propagated backward after a forward pass has been completed. In this way, for example, the machine learning model 342 may be trained to determine whether a document object model (DOM) copy is similar to a corresponding screenshot with better accuracy, recall, or precision.

In some embodiments, the machine learning model 342 may include an artificial neural network. In some embodiments, machine learning model 342 may include an input layer and one or more hidden layers. Each neural unit of the machine learning model may be connected with one or more other neural units of the machine learning model 342. Such connections can be enforcing or inhibitory in their effect on the activation state of connected neural units. Each individual neural unit may have a summation function which combines the values of all of its inputs together. Each connection (or the neural unit itself) may have a threshold function that a signal must surpass before it propagates to other neural units. The machine learning model 342 may be self-learning or trained, rather than explicitly programmed, and may perform significantly better in certain areas of problem solving, as compared to computer programs that do not use machine learning. During training, an output layer of the machine learning model 342 may correspond to a classification, and an input known to correspond to that classification may be input into an input layer of the machine learning model during training. During testing, an input without a known classification may be input into the input layer, and a determined classification may be output. For example, the classification may be an indication of whether an action is predicted to be completed by a corresponding deadline or not. The machine learning model 342 trained by the machine learning subsystem 114 may include one or more embedding layers at which information or data (e.g., any data or information discussed above in connection with FIGS. 1-3) is converted into one or more vector representations. The one or more vector representations of the message may be pooled at one or more subsequent layers to convert the one or more vector representations into a single vector representation.

The machine learning model 342 may be structured as a factorization machine model. The machine learning model 342 may be a non-linear model or supervised learning model that can perform classification or regression. For example, the machine learning model 342 may be a general-purpose supervised learning algorithm that the system uses for both classification and regression tasks. Alternatively, the machine learning model 342 may include a Bayesian model configured to perform variational inference. The machine learning model 342 may be configured to determine whether two datasets are similar, to generate a vector representation of a dataset or a portion of a dataset, or a variety of other functions described above in connection with FIGS. 1-2B.

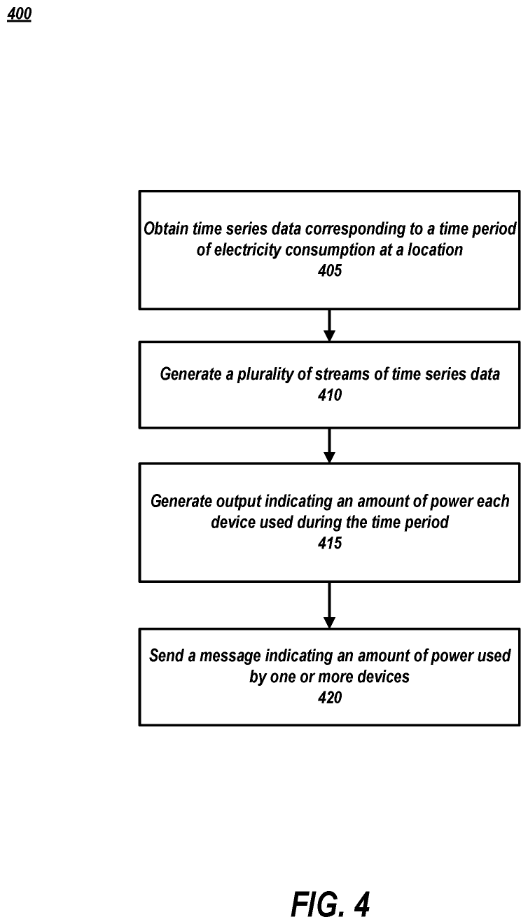

FIG. 4 is an example flowchart of processing operations of a method that enables the various features and functionality of the systems as described in detail above. The processing operations presented below are intended to be illustrative and non-limiting. In some embodiments, for example, the method may be accomplished with one or more additional operations not described, or without one or more of the operations discussed. Additionally, the order in which the processing operations of the methods are illustrated (and described below) is not intended to be limiting.

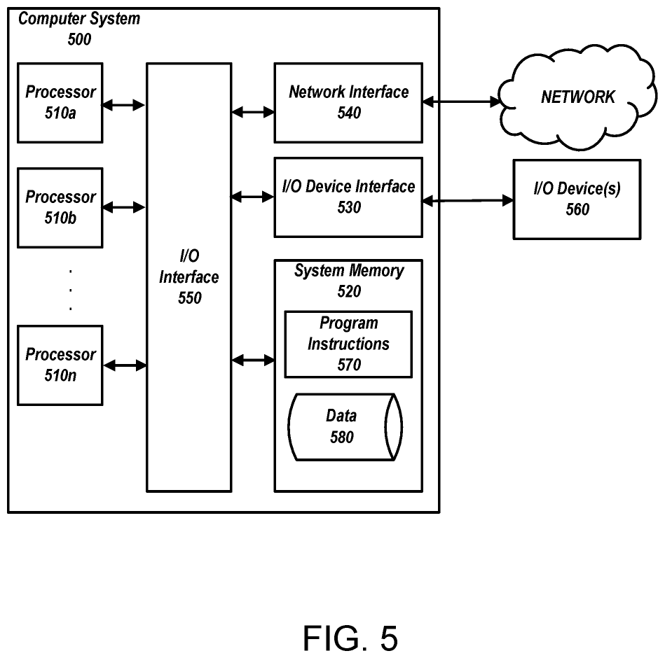

In some embodiments, the method may be implemented in one or more processing devices (e.g., a digital processor, an analog processor, a digital circuit designed to process information, an analog circuit designed to process information, a state machine, or other mechanisms for electronically processing information). The processing devices may include one or more devices executing some or all of the operations of the methods in response to instructions stored electronically on an electronic storage medium. The processing devices may include one or more devices configured through hardware, firmware, or software to be specifically designed for execution of one or more of the operations of the methods. It should be noted that the operations performed by power attribution system 102 may be performed using one or more components in system 100 (FIG. 1) or computer system 500 (FIG. 5).

FIG. 4 shows an example flowchart of the actions involved power consumption attribution. For example, process 400 may represent the actions taken by one or more devices shown in FIGS. 1-3 and described above. At 405, power attribution system 102 may obtain time series data corresponding to a time period of electricity consumption at a premises. The time series data may indicate a quantity of electricity used during each interval of a plurality of intervals within the time period. For example, the time series data may indicate how much power was consumed at a house every minute (e.g., plurality of intervals) for a time period of one month. The time series data may include weather information at the premises for each interval of the plurality of intervals. For example, the time series data may include the outside temperature for every minute during the time period of one month.

At 410, power attribution system 102 may generate a plurality of streams of time series data, for example, based on the time series data. Each stream of the plurality of streams may correspond to a device of the plurality of devices that has used electricity during the time period. The power attribution system 102 may use a machine learning model to determine the plurality of streams. Additionally or alternatively, the power attribution system 102 may use signal analysis techniques (e.g., the Fourier transform) to determine the plurality of streams. For example, the power attribution system 102 may determine a plurality of Fourier frequencies within the time series data. The power attribution system 102 may generate, based on the plurality of Fourier frequencies, the plurality of streams of time series data. The plurality of streams of time series data may be input into a machine learning model so that the machine learning model can identify a device for each of the streams. Alternatively, the time series data may be input into the machine learning model and the machine learning model may determine the streams and an identify or a device for each stream.

At 415, power attribution system 102 may generate output indicating an amount of power each device used during the time period. The output may be generated via the machine learning model, for example, in response to inputting the plurality of streams of time series data into the machine learning model. The output may include an identification of one or more devices that consumed power at the premises during the time period. The output may indicate an amount of power that each identified device consumed. The output may include an amount of power consumed by devices that the machine learning model was not able to identify. For example, the machine learning model may generate a confidence score for each identified device. If the confidence score is too low (e.g., below a threshold score), the power attribution system 102 may determine that no identification can be made for the corresponding device.

At 420, power attribution system 102 may send a message indicating an amount of power used by one or more devices at the premises. The message may be sent to the user device 104. The message may include a table listing the devices and an amount of power each device consumed. For example, the table may indicate that a computer used 15.6 kWh, a refrigerator used 30 kWh, and a clothes dryer used 24.8 kWh in one month.

It is contemplated that the actions or descriptions of FIG. 4 may be used with any other embodiment of this disclosure. In addition, the actions and descriptions described in relation to FIG. 4 may be done in alternative orders or in parallel to further the purposes of this disclosure. For example, each of these actions may be performed in any order, in parallel, or simultaneously to reduce lag or increase the speed of the system or method. Furthermore, it should be noted that any of the devices or equipment discussed in relation to FIGS. 1-3 or FIG. 5 could be used to perform one or more of the actions in FIG. 4.

FIG. 5 is a diagram that illustrates an exemplary computing system 500 in accordance with embodiments of the present technique. Various portions of systems and methods described herein may include or be executed on one or more computer systems similar to computing system 500. Further, processes and modules described herein may be executed by one or more processing systems similar to that of computing system 500.

Computing system 500 may include one or more processors (e.g., processors 510a-510n) coupled to system memory 520, an I/O device interface 530, and a network interface 540 via an I/O interface 550. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and I/O operations of computing system 500. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 520). Computing system 500 may be a units-processor system including one processor (e.g., processor 510a), or a multi-processor system including any number of suitable processors (e.g., 510a-510n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, (e.g., an FPGA (field-programmable gate array) or an ASIC (application-specific integrated circuit)). Computer system 500 may include a plurality of computing devices (e.g., distributed computer systems) to implement various processing functions.

I/O device interface 530 may provide an interface for connection of one or more I/O devices 560 to computer system 500. I/O devices may include devices that receive input (e.g., from a user) or output information (e.g., to a user). I/O devices 560 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 560 may be connected to computer system 500 through a wired or wireless connection. I/O devices 560 may be connected to computer system 500 from a remote premises. I/O devices 560 located on a remote computer system, for example, may be connected to computer system 500 via a network and network interface 540.

Network interface 540 may include a network adapter that provides for connection of computer system 500 to a network. Network interface 540 may facilitate data exchange between computer system 500 and other devices connected to the network. Network interface 540 may support wired or wireless communication. The network may include an electronic communication network, such as the Internet, a local area network (LAN), a wide area network (WAN), a cellular communications network, or the like.

System memory 520 may be configured to store program instructions 570 or data 580. Program instructions 570 may be executable by a processor (e.g., one or more of processors 510a-510n) to implement one or more embodiments of the present techniques. Program instructions 570 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 520 may include a tangible program carrier having program instructions stored thereon. A tangible program carrier may include a non-transitory computer-readable storage medium. A non-transitory computer-readable storage medium may include a machine-readable storage device, a machine-readable storage substrate, a memory device, or any combination thereof. Non-transitory computer-readable storage medium may include non-volatile memory (e.g., flash memory, ROM, programmable read-only memory (PROM), erasable programmable read-only memory (EPROM), EEPROM memory), volatile memory (e.g., RAM, static random access memory (SRAM), synchronous dynamic RAM (SDRAM)), bulk storage memory (e.g., CD-ROM or DVD-ROM, hard-drives), or the like. System memory 520 may include a non-transitory computer-readable storage medium that may have program instructions stored thereon that are executable by a computer processor (e.g., one or more of processors 510a-510n) to cause the subject matter and the functional operations described herein. A memory (e.g., system memory 520) may include a single memory device or a plurality of memory devices (e.g., distributed memory devices).

I/O interface 550 may be configured to coordinate I/O traffic between processors 510a-510n, system memory 520, network interface 540, I/O devices 560, or other peripheral devices. I/O interface 550 may perform protocol, timing, or other data transformations to convert data signals from one component (e.g., system memory 520) into a format suitable for use by another component (e.g., processors 510a-510n). I/O interface 550 may include support for devices attached through various types of peripheral buses, such as a variant of the Peripheral Component Interconnect (PCI) bus standard or the USB standard.

Embodiments of the techniques described herein may be implemented using a single instance of computer system 500 or multiple computer systems 500 configured to host different portions or instances of embodiments. Multiple computer systems 500 may provide for parallel or sequential processing/execution of one or more portions of the techniques described herein.

Those skilled in the art will appreciate that computer system 500 is merely illustrative and is not intended to limit the scope of the techniques described herein. Computer system 500 may include any combination of devices or software that may perform or otherwise provide for the performance of the techniques described herein. For example, computer system 500 may include or be a combination of a cloud computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 500 may also be connected to other devices that are not illustrated or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. In some embodiments, some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 500 may be transmitted to computer system 500 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present disclosure may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted. For example, such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine-readable medium. In some cases, third-party content delivery networks may host some or all of the information conveyed over networks, in which case, to the extent information (e.g., content) is said to be supplied or otherwise provided, the information may be provided by sending instructions to retrieve that information from a content delivery network.

Due to costs constraints, some features disclosed herein may not be presently claimed and may be claimed in later filings, such as continuation applications or by amending the present claims. Similarly, due to space constraints, neither the Abstract nor the Summary section of the present document should be taken as containing a comprehensive listing of all such disclosures or all aspects of such disclosures.

It should be understood that the description and the drawings are not intended to limit the disclosure to the particular form disclosed, but to the contrary, the intention is to cover all modifications, equivalents, and alternatives falling within the spirit and scope of the present disclosure as defined by the appended claims. Further modifications and alternative embodiments of various aspects of the disclosure will be apparent to those skilled in the art in view of this description. Accordingly, this description and the drawings are to be construed as illustrative only and are for the purpose of teaching those skilled in the art the general manner of carrying out the disclosure. It is to be understood that the forms of the disclosure shown and described herein are to be taken as examples of embodiments. Elements and materials may be substituted for those illustrated and described herein, parts and processes may be reversed or omitted, and certain features of the disclosure may be utilized independently, all as would be apparent to one skilled in the art after having the benefit of this description of the disclosure. Changes may be made in the elements described herein without departing from the spirit and scope of the disclosure as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include,” “including,” and “includes” and the like mean including, but not limited to. As used throughout this application, the singular forms “a,” “an,” and “the” include plural referents unless the content explicitly indicates otherwise. Thus, for example, reference to “an element” or “the element” includes a combination of two or more elements, notwithstanding use of other terms and phrases for one or more elements, such as “one or more.” The term “or” is, unless indicated otherwise, non-exclusive (i.e., encompassing both “and” and “or”). Terms describing conditional relationships (e.g., “in response to X, Y,” “upon X, Y,” “if X, Y,” “when X, Y,” and the like) encompass causal relationships in which the antecedent is a necessary causal condition, the antecedent is a sufficient causal condition, or the antecedent is a contributory causal condition of the consequent (e.g., “state X occurs upon condition Y obtaining” is generic to “X occurs solely upon Y” and “X occurs upon Y and Z”). Such conditional relationships are not limited to consequences that instantly follow the antecedent obtaining, as some consequences may be delayed, and in conditional statements, antecedents are connected to their consequents (e.g., the antecedent is relevant to the likelihood of the consequent occurring). Statements in which a plurality of attributes or functions are mapped to a plurality of objects (e.g., one or more processors performing actions A, B, C, and D) encompass all such attributes or functions being mapped to all such objects as well as subsets of the attributes or functions being mapped to subsets of the attributes or functions (e.g., both all processors each performing actions A-D, and a case in which processor 1 performs action A, processor 2 performs action B and part of action C, and processor 3 performs part of action C and action D), unless otherwise indicated. Further, unless otherwise indicated, statements that one value or action is “based on” another condition or value encompass both instances in which the condition or value is the sole factor and instances in which the condition or value is one factor among a plurality of factors. The term “each” is not limited to “each and every” unless indicated otherwise. Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems or methods described above may be applied to, or used in accordance with, other systems or methods.

The present techniques will be better understood with reference to the following enumerated embodiments:

1. A method comprising obtaining time series data corresponding to a time period of electricity consumption at a location; inputting the time series data into a machine learning model; generating, via the machine learning model, output comprising an identification of each device of the plurality of devices or an amount of power each device of the plurality of devices used during the time period; and sending, to a user device, a notification indicating a quantity of power used by a first device of the plurality of devices.

2. The method of any of the previous embodiments, wherein generating the output comprises determining a plurality of streams within the time series data and generating, based on the plurality of streams, the output.

3. The method of any of the previous embodiments, further comprising: determining that a subset of the plurality of streams of time series data corresponds to a first type of device; and based on determining that the subset corresponds to the first type of device, aggregating the output for each stream in the subset.

4. The method of any of the previous embodiments, further comprising: determining, based on a plurality of previous output of the machine learning model, that power consumption by the first device has increased over a threshold period of time; and in response to determine that power consumption by the first device has increased over a threshold period of time, sending an indication that power consumption by the first device has increased to the user device.

5. The method of any of the previous embodiments, further comprising: determining that a first stream of the plurality of streams of time series data corresponds to the first device; determining, based on an anomaly detection model, that the first stream comprises an anomaly; and in response to determining that the first stream comprises an anomaly, sending, to the user device, a recommendation to repair the first device.

6. The method of any of the previous embodiments, further comprising: in response to inputting the time series data into the machine learning model, receiving, from the machine learning model, second output indicating that a new device is consuming electricity at the location; and in response to receiving second output indicating that a new device is consuming electricity, sending a second notification to the user device.

7. The method of any of the previous embodiments, further comprising: comparing the output with previous data generated by the machine learning model; based on comparing the output with previous data generated by the machine learning model, determining that a second device is missing from the output; and in response to determining that a second device is missing from the output, sending a second notification to the user device, wherein the second notification indicates that the second device is off.

8. The method of any of the previous embodiments, wherein sending the second notification comprises: receiving user input indicating a plurality of critical devices that consume electricity at the location; determining that the plurality of critical devices comprises the second device; and in response to determining that the plurality of critical devices comprises the second device, sending the second notification.

9. A tangible, non-transitory, machine-readable medium storing instructions that, when executed by a data processing apparatus, cause the data processing apparatus to perform operations comprising those of any of embodiments 1-8.

10. A system comprising: one or more processors; and memory storing instructions that, when executed by the processors, cause the processors to effectuate operations comprising those of any of embodiments 1-8.

11. A system comprising means for performing any of embodiments 1-8.

What is claimed is:

1. A system for using machine learning and time series power consumption data to determine home devices and how much power is consumed by each of the home devices, the system comprising:
storage circuitry configured to store a machine learning model, wherein the machine learning model is trained to determine, based on time series data, a plurality of devices and an amount of power consumed by each device of the plurality of devices; and
control circuitry that performs operations comprising:
obtaining time series data corresponding to a time period of electricity consumption at a location, wherein the time series data indicates a quantity of electricity used during each interval of a plurality of intervals within the time period, wherein the time series data comprises weather information at the location for each interval of the plurality of intervals;
generating, based on the time series data, a plurality of streams of time series data, each stream of the plurality of streams corresponding to a device of the plurality of devices that has used electricity during the time period;
inputting the plurality of streams of time series data into the machine learning model;
in response to inputting the plurality of streams of time series data into the machine learning model, receiving, from the machine learning model, output comprising an identification of each device of the plurality of devices and an amount of power each device of the plurality of devices used during the time period; and
sending, to a user device, a notification indicating a quantity of power used by a first device of the plurality of devices.

2. The system of claim 1, wherein the control circuitry is configured to perform operations further comprising:
determining that a first stream of the plurality of streams of time series data corresponds to the first device;
determining, based on an anomaly detection model, that the first stream comprises an anomaly; and
in response to determining that the first stream comprises an anomaly, sending, to the user device, a recommendation to repair the first device.

3. The system of claim 1, wherein the control circuitry is configured to perform operations further comprising:
in response to inputting the plurality of streams of time series data into the machine learning model, receiving, from the machine learning model, second output indicating that a new device is consuming electricity at the location; and
in response to receiving second output indicating that a new device is consuming electricity, sending a second notification to the user device.

4. The system of claim 1, wherein the control circuitry is configured to perform operations further comprising:
comparing the output with previous data generated by the machine learning model;
based on comparing the output with previous data generated by the machine learning model, determining that a second device is missing from the output; and
in response to determining that a second device is missing from the output, sending a second notification to the user device, wherein the second notification indicates that the second device is off.

5. A method comprising:
obtaining time series data corresponding to a time period of electricity consumption at a location;
inputting the time series data into a machine learning model, wherein the machine learning model has been trained to identify, based on received time series data comprising electricity consumption patterns, devices and amounts of electricity consumed by the devices;
in response to inputting the time series data into the machine learning model, generating, via the machine learning model, output comprising an identification of each device of the plurality of devices and an amount of power each device of the plurality of devices used during the time period; and
sending, to a user device, a notification indicating a quantity of power used by a first device of the plurality of devices.

6. The method of claim 5, wherein generating the output comprises:
determining a plurality of streams within the time series data; and
generating, based on the plurality of streams, the output.

7. The method of claim 5, further comprising:
determining that a subset of the plurality of streams of time series data corresponds to a first type of device; and
based on determining that the subset corresponds to the first type of device, aggregating the output for each stream in the subset.

8. The method of claim 5, further comprising:
determining, based on a plurality of previous output of the machine learning model, that power consumption by the first device has increased over a threshold period of time; and
in response to determining that power consumption by the first device has increased over a threshold period of time, sending an indication that power consumption by the first device has increased to the user device.

9. The method of claim 5, further comprising:
determining that a first stream of the plurality of streams of time series data corresponds to the first device;
determining, based on an anomaly detection model, that the first stream comprises an anomaly; and
in response to determining that the first stream comprises an anomaly, sending, to the user device, a recommendation to repair the first device.

10. The method of claim 5, further comprising:
in response to inputting the time series data into the machine learning model, receiving, from the machine learning model, second output indicating that a new device is consuming electricity at the location; and
in response to receiving second output indicating that a new device is consuming electricity, sending a second notification to the user device.

11. The method of claim 5, further comprising:
comparing the output with previous data generated by the machine learning model;
based on comparing the output with previous data generated by the machine learning model, determining that a second device is missing from the output; and
in response to determining that a second device is missing from the output, sending a second notification to the user device, wherein the second notification indicates that the second device is off.

12. The method of claim 11, wherein sending the second notification comprises:
receiving user input indicating a plurality of critical devices that consume electricity at the location;
determining that the plurality of critical devices comprises the second device; and
in response to determining that the plurality of critical devices comprises the second device, sending the second notification.

13. A non-transitory, computer-readable medium comprising instructions that when executed by one or more processors, causes operations comprising:
obtaining time series data corresponding to a time period of electricity consumption at a location;
inputting the time series data into a machine learning model, wherein the machine learning model is trained to identify devices based on electricity consumption data;
in response to inputting the time series data into the machine learning model, receiving, from the machine learning model, output comprising an identification of each device of the plurality of devices and an amount of power each device of the plurality of devices used during the time period; and
sending, to a user device, a notification indicating a quantity of power used by a first device of the plurality of devices.

14. The computer-readable medium of claim 13, wherein generating the output comprises:
determining a plurality of streams within the time series data; and
generating, based on the plurality of streams, the output.

15. The computer-readable medium of claim 13, wherein the instructions, when executed, cause operations further comprising:
determining that a subset of the plurality of streams of time series data corresponds to a first type of device; and
based on determining that the subset corresponds to the first type of device, aggregating the output for each stream in the subset.

16. The computer-readable medium of claim 13, wherein the instructions, when executed, cause operations further comprising:
determining, based on a plurality of previous output of the machine learning model, that power consumption by the first device has increased over a threshold period of time; and
in response to determining that power consumption by the first device has increased over a threshold period of time, sending an indication that power consumption by the first device has increased to the user device.

17. The computer-readable medium of claim 13, wherein the instructions, when executed, cause operations further comprising:
determining that a first stream of the plurality of streams of time series data corresponds to the first device;
determining, based on an anomaly detection model, that the first stream comprises an anomaly; and
in response to determining that the first stream comprises an anomaly, sending, to the user device, a recommendation to repair the first device.

18. The computer-readable medium of claim 13, wherein the instructions, when executed, cause operations further comprising:
in response to inputting the time series data into the machine learning model, receiving, from the machine learning model, second output indicating that a new device is consuming electricity at the location; and
in response to receiving second output indicating that a new device is consuming electricity, sending a second notification to the user device.

19. The computer-readable medium of claim 13, wherein the instructions, when executed, cause operations further comprising:
comparing the output with previous data generated by the machine learning model;
based on comparing the output with previous data generated by the machine learning model, determining that a second device is missing from the output; and
in response to determining that a second device is missing from the output, sending a second notification to the user device, wherein the second notification indicates that the second device is off.

20. The computer-readable medium of claim 19, wherein sending the second notification comprises:
receiving user input indicating a plurality of critical devices that consume electricity at the location;
determining that the plurality of critical devices comprises the second device; and
in response to determining that the plurality of critical devices comprises the second device, sending the second notification.
